(19) United States
(12) Patent Application Publication
(10) Pub. No.: US 2026/0097308 A1
(43) Pub. Date: Apr. 9, 2026

(54) LIVE VOICE SYNTHETIZATION

(71) Applicant: Microsoft Technology Licensing, LLC, Redmond, WA (US)

(72) Inventors: Mastafa Hamza FOUFA, Seattle, WA (US); Corentin Alexandre BRAUGE, Tokyo (JP)

(21) Appl. No.: 18/907,242

(22) Filed: Oct. 4, 2024

(51) Int. Cl. A63F 13/54; A63F 13/215; G10L 13/033; G10L 13/047; G10L 21/007; G10L 25/18

(52) U.S. Cl. CPC A63F 13/54; A63F 13/215; G10L 13/033; G10L 13/047; G10L 21/007; G10L 25/18

(57) ABSTRACT

Systems, devices, methods, and machine-readable media configured to provide voice synthetization in a multiplayer video game are provided. A system can include a multiplayer video game including a character selection interface through which a player selects a character to represent them in playing the video game, and a voice model trained to convert audio from the player directly into audio in a voice of the character and provide an output that includes the audio in the voice of the character.

### BACKGROUND

Those who play multiplayer role play games desire a more immersive experience. Currently these role play games are typically played with users controlling respective characters that are represented by graphics. The users will often wear headsets through which they communicate with other users playing the game. The voice of the user is typically their own voice, which does not match the build of the character they are controlling. This sort of experience is not very immersive and makes it difficult for the users to suspend disbelief.

### SUMMARY

Embodiments regard systems, devices, methods, and computer-readable media for live voice synthetization. Live voice synthetization can help preserve privacy of multiplayer video game players and reduce cyber bullying. The voice synthetization further helps improve the immersive quality of a role playing game by making a voice of a character better match the build of the character.

A system can include a multiplayer video game. The multiplayer video game can include a character selection interface through which a player selects a character to represent them in playing the video game. The system can include a voice model trained to convert audio from the player directly into audio in a voice of the character and provide an output that includes the audio in the voice of the character.

The trained voice model can include a sequence-to-sequence model that converts a spectrogram of the audio from the player to a spectrogram consistent with the voice of the character. The multiplayer video game can be configured to generate a game log including data indicating character states of characters, including a character state of the character, of the multiplayer video game.

The system can further include a character state model. The character state model can be trained to (i) generate, based on the game log, a character state of the character and (ii) provide the character state as input to the trained voice model. The character state can be constrained to include only parameters of the character state that affect the voice of the character and that the trained voice model uses to alter the voice of the character. The state of the players can represent an environment about the characters in the video game, a physical state of the characters in the video game, and a movement state of the characters in the video game.

The trained voice model can include one or more of a trained character voice model trained to generate, for a plurality of characters including the character and for a plurality of character states, a character spectrogram consistent with a selected character and a given character state, and a vocoder configured to synthesize the audio in the voice of the character based on the character spectrogram.

The system can further include a speaker encoder model trained to generate a speaker encoding of the audio of the player and provide the speaker encoding as input to the trained character voice model. The trained character voice model can maintain characteristics of the voice of the player in the player audio in the voice of the character. The characteristics can include volume, rhythm, and rate. The multiplayer video game can be configured to update the game log for each frame of the video game and the character state can be updated for each frame.

A method can include receiving, from a multiplayer video game and at a trained voice model, character data indicating a character selected by a player of the video game to represent them in playing the video game. The method can further include converting, by the trained voice model, audio from the player directly into audio in a voice of the character. The method can further include providing, by the trained voice model, the audio in the voice of the character to another player of the video game.

The trained voice model can include a sequence-to-sequence model that is trained, in a supervised manner, to convert a spectrogram of the audio from the player to a spectrogram consistent with the voice of the character. Converting the audio from the player can be performed based on a game log that includes data indicating a state of characters, including the character, actively operating in the video game.

The method can further include receiving, from a character state model and at the trained voice model, the character state, the character state model trained to generate, based on the game log, the character state of the character. The method can further include, wherein the character state is constrained to include only parameters of the character state that affect the voice of the character and that the trained voice model uses to alter the voice of the character. The character state of the players can include an environment about the characters in the video game, a physical state of the characters in the video game, and a movement state of the characters in the video game. The trained voice model can include a trained character voice model trained to generate, for a plurality of characters including the character and for a plurality of character states, a character spectrogram consistent with a selected character and a given character state, and a vocoder configured to synthesize the audio in the voice of the character based on the character spectrogram.

A machine-readable medium can include instructions stored thereon that, when executed by a machine, cause the machine to perform the method.

### BRIEF DESCRIPTION OF THE DRAWINGS

FIG. 1 illustrates, by way of example, a diagram of an embodiment of a system for voice synthetization.

FIG. 2 illustrates, by way of example a flow diagram of an embodiment of a method for generating a trained character voice model.

FIG. 3 illustrates, by way of example, an exploded view diagram of embodiments of the trained voice model and corresponding inputs.

FIG. 4 illustrates, by way of example, a diagram of an embodiment of a method for voice synthetization in a video game.

FIG. 5 is a block diagram of an example of an environment including a system for neural network (NN) training.

FIG. 6 is a block schematic diagram of a computer system for performing methods and algorithms according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

A real-time or near real-time synthesized voice in a multiplayer video game would help multi-player video game players suspend disbelief in playing the video game. Further, the real-time or near real-time synthesized voice would help preserve anonymity and privacy of the user.

Voice synthetization (synthesizing audio from a video game player into a synthetic voice) in a game includes a player choosing a character to play. The character has an expected voice. Then, when the player speaks into a microphone while playing the game as the character, speech of the player is converted to the voice of the character before it is presented to other players. In short, when a player speaks to other players in the game, their voices get synthesized in the voice of the character. For instance, if the character is Masterchief in HALO®, the player would sound like Masterchief to the other players in the session. The voice can further include special sound effects, like having the voice sound like they are speaking through a helmet, the character is tired, injured, angry, happy, a combination thereof, or the like.

Current online games are closed loop systems that do not, or rarely, interface with an external system. Multiplayer online games are live experiences and it is not feasible for the players to stop playing to use an external system to change their voice. Thus, many solutions to voice synthetization are not usable in the context of multiplayer games. The voice synthetization provides multiplayer video game players with an ability to change their voice, allowing the players to have a voice more consistent with the expected voice of their selected character.

Voice synthetization increases privacy and reduces the risk of bullying of the player. When playing online with voice chat, female players and children are more likely to be harassed than other players. Using the voice synthetization, the human characteristics of the human player are not shared to the other players and are not discernible by the synthesized voice. The voice synthesizing thus helps prevent a source of the harassment. Note that synthetization and synthesizing are used interchangeable herein.

The voice synthetization allows any user to have better immersion while playing online games. This voice synthetization thus increases the suspension of disbelief in playing of the game.

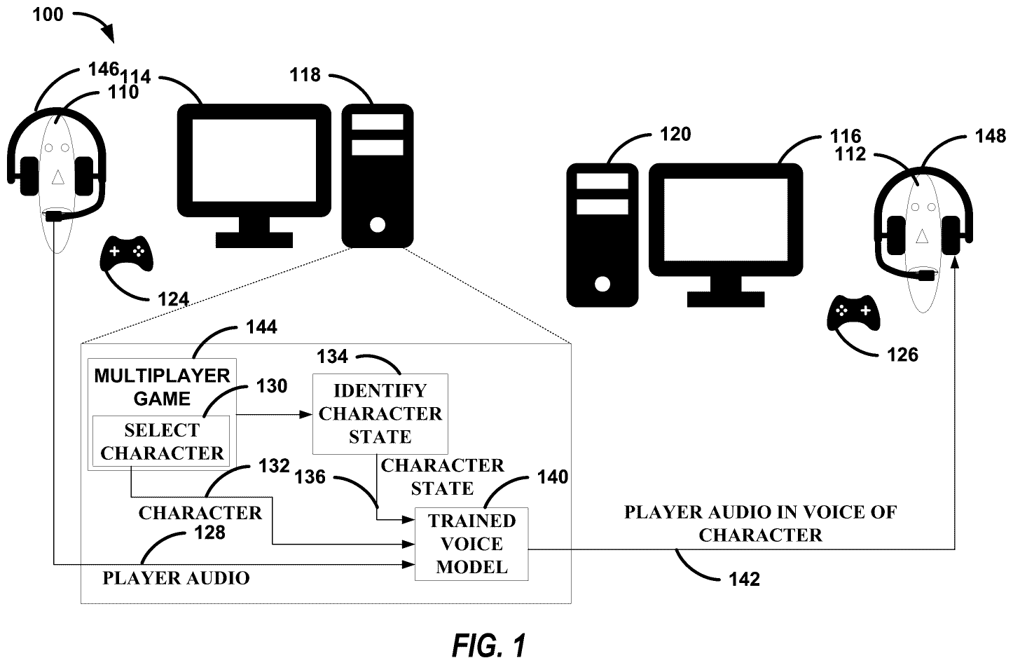

FIG. 1 illustrates, by way of example, a diagram of an embodiment of a system 100 for voice synthetization. The system 100 as illustrated includes users 110, 112 of a multiplayer game 144 that access the multiplayer game 144 through a compute device 118. The multiplayer game 144 can be hosted locally on one or more of the compute devices 118, 120. The multiplayer game 144 can be hosted remotely, such as in the cloud, and accessible through the internet. In some instances, a portion of the multiplayer game is hosted locally, and a portion of the multiplayer game is hosted remotely. The users 110, 112 often wear respective headsets 146, 148 that include speakers (e.g., over the ear speakers) and a microphone. The users 110, 112 often play the game using a controller 124, 126 that is communicatively coupled to the compute device 118. The users 110, 112 watch their progress in the game through respective displays 114, 116 communicatively coupled to the respective compute devices 118, 120.

The compute device 118, 120 can include any device capable of executing a multiplayer game. The compute device 118, 120 and display 114, 116 while illustrated as a desktop computer and a separate display device in separate packages, can alternatively include a handheld device, a laptop computer, an extended reality (XR) headset (e.g., a virtual reality (VR), augmented reality (AR) headset, or the like), that include components and a display in a single device package.

To perform voice synthetization, the compute devices 118, 120 can each use a trained voice model 140. The trained voice model 140 converts player audio 128 into player audio in the voice of the character 142. Using the trained voice model 140, the user 110 can speak to generate the player audio 128, but the player audio 128 is presented as the player audio in the voice of the character 142 to other users 112 of the game.

The trained voice model 140 can include a neural network (NN). The trained voice model 140 can be trained in a supervised or semi-supervised manner to convert a spectrogram of the player audio 128 into a spectrogram consistent with a selected character 132.

The trained voice model 140 can operate based on input that includes the player audio 128, a selected character 132, and a character state 136. The player audio 128 is the audio provided by the user 110.

The character 132 is the avatar and corresponding characteristics of an entity that the user can use to represent themself in gameplay. A user, when launching a game for a first time, is given a selection of characters to choose from by a select character interface 130. The user often selects a character that they relate to, aspire to be, admire, or the like. The select character interface 130 is presented as a graphical display through which the player 110 (sometimes called a “user”), using the controller 124 for example, can select a character they wish to represent them in playing the game. The characteristics of the character 132 include their speed, strength, capabilities, look, and the like.

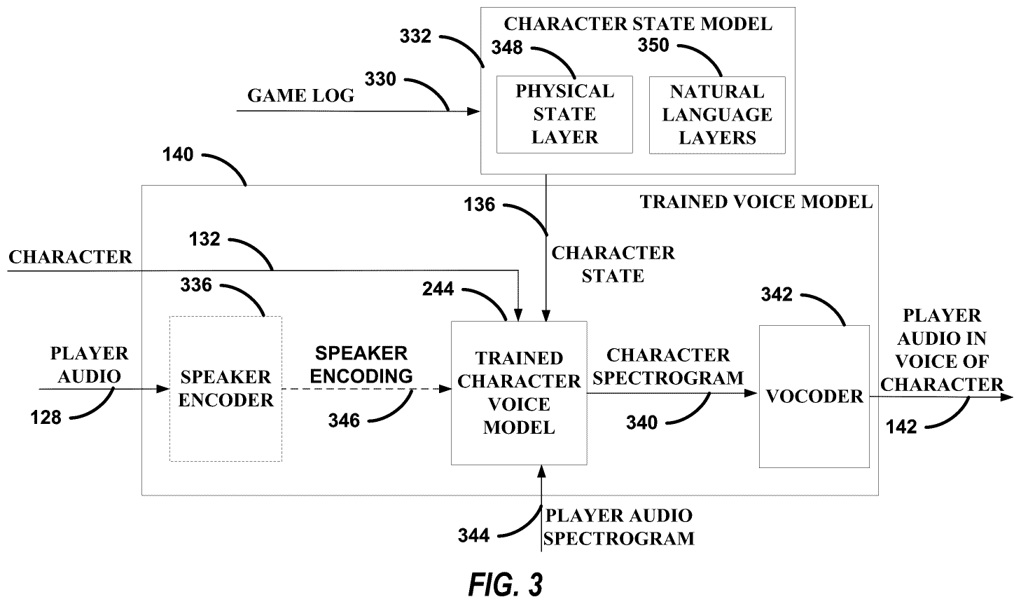

The character state 136 includes data of a current situation of the character 132 within the game. The data of the current situation can be limited to include only elements that affect the voice of the character 142. The character state 136 identifies, for example, whether the character, in the game and at a current moment in time, is in transit or at rest, if the character is in transit what type of transit (e.g., walking, jogging, running, in a vehicle, or the like), an implement the character is wearing anything on their face (e.g., mask, armor, dental implement, or the like), an energy level of the character (e.g., tired, energetic, sleepy, or the like), among others. The character state 136 can be determined by an identify character state operation 134. The identify character state operation 134 can be determined by a trained ML model that classifies the character state 136. The operation 134 can be performed based on input that can include a game log (see FIG. 3). The game log is discussed in more detail elsewhere.

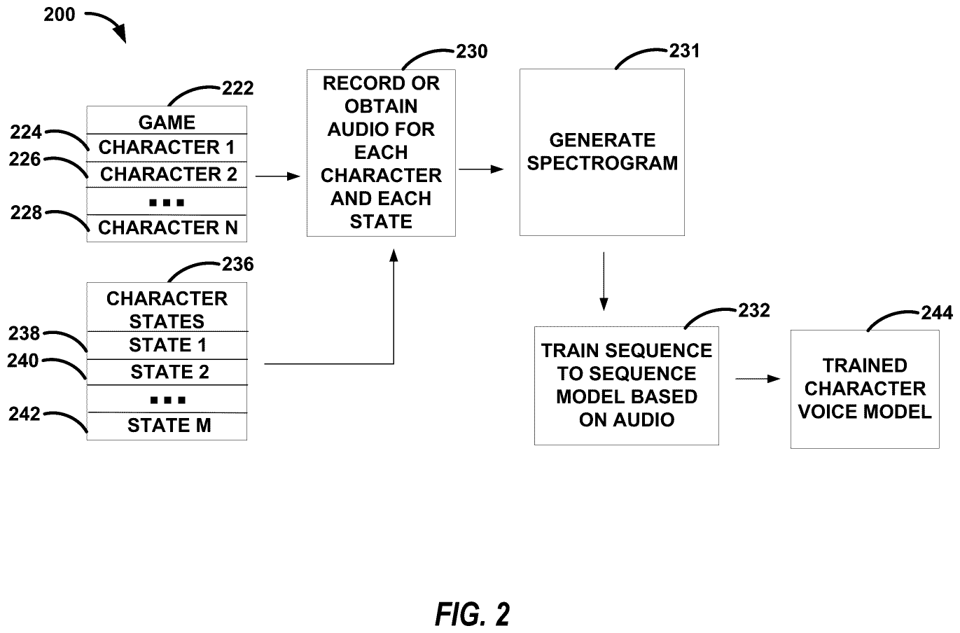

FIG. 2 illustrates, by way of example a flow diagram of an embodiment of a method 200 for generating a trained character voice model 244. The method 200 as illustrated includes identifying characters 224, 226, 228 of a game 222 and states 238, 240, 242 of possible character states 236 that affect the audio of the character 224, 226, 228. For each of the characters 224, 226, 228 and the states 238, 240, 242 audio can be recorded or obtained at operation 230. The operation 230 can include using voice actors, props, ML models, vocal effects processors, sound effects, or the like to generate the audio for each character 224, 226, 228 in each state 238, 240, 242 relevant to the character 224, 226, 228. One or more characters 224, 226, 228 may be able to be in states 238, 240, 242 that are not applicable to other characters 224, 226, 228. For example, a character may be unable to run or jog and those characters thus cannot be in a running or jogging state. The audio for each character 224, 226, 228 can be recorded or obtained for only those states 238, 240, 242 that are applicable to the character 224, 226, 228.

A spectrogram for each audio sample, from the operation 230, can be generated at operation 231. The operation 231 can include using a Fourier transform, such as a short-time Fourier transform (STFT), to generate a spectrogram. A spectrogram of player audio 344 is illustrated in FIG. 3. The player audio 344 can be generated using an STFT. The spectrogram can be generated by dividing audio into short overlapping segments. Those segments can then be processed by a Fourier map or transform to provide the underlying frequency content and corresponding amplitudes. For each segment, we then have a Fourier transform. The Fourier transforms can be combined to produce a final spectrogram that is readable by the sequence-to-sequence model. Each point of the final spectrogram represents the intensity of a particular frequency at a certain time. The spectrogram can include datapoint triplets (e.g., <frequency, time, intensity>). Each triplet describes the frequency spectrum of the sound signal from the end-user over a time slice.

A sequence-to-sequence model can be trained, at operation 232, based on the spectrogram generated at operation 231, the audio recorded at operation 230, or a combination thereof. A sequence-to-sequence model translates a first sequence into a second sequence. The sequence-to-sequence model can include one or more transformers that use self-attention, cross-attention, or a combination thereof. The sequence-to-sequence model can include an encoder with an attention mechanism, known as a context vector. The encoder processes the audio input and captures important information, which is stored as a hidden state. The context vector is a weighted sum of input hidden states and is generated for every time instance of the output sequence. The decoder takes the context vector and hidden states from the encoder and generates the final output sequence. In decoder operates in an autoregressive manner, producing one element of the output sequence at a time. The decoder considers previously generated elements, context vector, and input sequence information to generate the next element of the output sequence. In a model with attention, the context vector and the hidden state are concatenated to form an attention hidden vector.

A result of the training operation 232 is a trained voice character model 244. More details regarding the training at operation 232 are provided elsewhere.

The trained voice character model 244 operates on the player audio 128 to generate player audio in the voice of the character 142. The trained voice character model 244 operates without translating the input audio to an intermediate text representation. The intermediate text representation is often used to translate input audio into another language. Using the intermediate text representation, a user provides audio, which is converted to an intermediate text representation and then decoded to another language. Using the trained voice character model 244, in contrast, a spectrogram of the player audio 128 is converted directly to a spectrogram of the player audio in the voice of the character 142. Directly, in this context, means that the model 244 does not generate the intermediate text representation. The intermediate text representation is cost and time prohibitive and is not required for converting the player audio 128 into audio in the voice of the character 142. The intermediate text representation is not needed, at least in part, because translation is not the goal. The goal of the trained voice character model 244 is instead to convert waveform patterns of the player audio 128 into waveform patterns consistent with the waveform patterns of the selected character 132.

More formally, given a game, G, and a set of N characters, where N is a positive integer greater than one, assume that the voices for each character in each possible state are represented by {v1, v2, . . . , vN} . The voice character model 244, f, takes the player audio 128 of the user 110 and converts each spoken token to the voice of the selected character 132. Let T be the series of tokens spoken by the player and representing the player audio 128. So let T={t1, t2, . . . , tN} and i be the ith character selected by the individual, then the model operates to generate: f(T, i)=fi(T).

To train fi, a single attentive sequence-to-sequence model without intermediate text representation is generated. A source spectrogram from the player audio 128 is generated and provided as input to the model along with the selected character. The model is trained to generate spectrograms of the player audio in the voice of the character 142.

During training, the sequence-to-sequence model uses a multitask objective to predict source and target transcripts while also generating target spectrograms. However, no transcripts or other intermediate text representations are generated by the model or used by the model during inference. Training the model can be accomplished using a set of pre-recorded input voices from a wide variety of individuals and the mapped target voices generated or obtained at operation 230 of the in-game characters. The training can be accomplished within in-domain data. In-domain data takes into consideration the uniqueness of an in-game vocabulary. In-domain data is contrasted with universal vocabulary, which is realized by a model trained by a wider variety of contexts. Examples of wider contexts include Wikipedia or Reddit data that are not constrained to a single game environment. Some words, and corresponding tokens, to be spoken by the character 132 can be more prevalent in the context of the game than in the universal context. Further, the pronunciation of some of these words may be unique to the game context and can be important to providing a user with an optimally immersive gaming experience. The pronunciation in the context of the game might be better understood with an example. A game may include a town with the name “Nevada”. In a more universal context, the word “Nevada” can be a heteronym for the same word in the game context. For example, in the universal context, it can be understood that “Nevada” is pronounced as “Ne-vad-uh” while, in the game context, “Nevada” is pronounced as “Ne-vay-duh”. It is thus important to have the trained character voice model 140 trained based on in-domain pronunciations of the words.

The trained voice model 140 can further include one or more other separately trained components: a neural vocoder 342 (see FIG. 3) that converts output spectrograms to time-domain waveforms, and, optionally, a speaker encoder 336 (see FIG. 3) that can help maintain the character of the voice of the user 110 in the player audio in the voice of the character 142.

FIG. 3 illustrates, by way of example, an exploded view diagram of embodiments of the trained voice model 140 and corresponding inputs. The trained voice model 140 as illustrated includes (i) an optional speaker encoder 336 that provides a speaker encoding 346 to the trained character voice model 244 (ii) and the trained character voice model 244 that provides a character spectrogram 340 to a neural vocoder 342 that generates the player audio in the voice of the character 142.

The speaker encoder 336 is pretrained on a speaker verification task. The speaker verification task is an authentication task that determines whether a person is who they claim they are. The speaker encoder 336 is trained to encode speaker characteristics from a short example utterance. Conditioning the trained character voice model 244 on an encoding causes the trained character voice model 244 to produce synthesize speech with similar speaker characteristics to those in the player audio 128, even though the player audio in the voice of the character 142 is in a different voice format (e.g., difference frequency spectrum, rate, rhythm, volume, tone, tenor, pitch, a combination thereof, or the like). Since the trained character voice model 244 is largely preserving language it can more easily preserve speaker characteristics as compared to a translator model.

The trained character voice model 244 can receive or generate a user audio spectrogram 344, the selected character 132, the character state 136, the speaker encoding 346, or a combination thereof. The trained character voice model 244 generates a character spectrogram 340. The user audio spectrogram 344 indicates a time series of characteristics of the player audio. The user audio spectrogram 344 can detail frequency and amplitude data for the audio in a series of timeframes. The timeframes of the spectrogram 344 can be consistent with frames of the video game. The character spectrogram 340 is the user audio spectrogram with altered to be consistent with the audio characteristics of the character 132.

The character state 136 can be determined by a trained character state model 332 that is distinct from the trained voice model 140. The character state model 332 can take a game log 330 as input and generate the character state 136 as output. The game log 330 is generated per each time slice, sometimes called a “frame”, of the multiplayer game. The game log 330 details a state of each character in the game. The game log 330, however, includes many details that are not relevant to the voice of the character 132. The details in the game log 330 that are not relevant to the character 132 can be filtered by the character state model 332 leaving just the relevant character state 136 as input to the trained character voice model 244.

Multiplayer games can be a series of in-game frames that are converted to audio and video. With each frame, F, there is a lot of information that can include a non-exhaustive list of parameters, P. The parameters, P, are the state of the character, such as whether the character is bleeding, the character tiredness, the character emotional state (e.g., whether they are angry, happy, sad, etc.), whether the character is wearing a helmet, or the like. Those parameters are not trivially filtered out since they are encapsulated in an abstract coded object representing a frame and dynamically populated during the game. The character can thus be represented by an object class, character, with several parameters that are dynamically populated across the game. Those parameters can be filtered using a specific model focusing on those described objects available in the logs for example.

In many multiplayer games, the environmental effects on audio are managed by in-game audio rendering, such as audio raytracing for directional effects. For example, one system that receives the game log 330 and is responsible for applying environmental effects to the voice, such as echo or reflection on metal. The trained voice model 140 operates independent of such an environmental effects system and does not alter operation of the environmental effects system.

The character state model 332, represented as a function, g, takes as input the current frame and character's state information, jointly represented as the game log 330, and returns a set of parameters known the current state of the character, the character state 136, immersed in the gameplay. g(frame)=P where P describes the list of all key parameters required to fully understand how and where the character is within the game.

A layer 348 of g focuses on the physical state of the character. For example, in a game in which a life level is used, the model 332 receives as input the life level of the displayed character and returns a meaningful label. The label can be in a string format, for example: {“dying”, “almost dying”, “well”, “very well”}.

The model 332 can also leverage a time series of the game log 330 to understand more granular information about the displayed character such as whether it was physically damaged, such as by a gun bullet, a recent fight, or the like and whether the character 132 is recovering. To add structure to the game log 330, natural language processing (NLP), such as with a language model (LM) 350 (e.g., a large language model (LLM)) that takes as input the logged state of the main character and returns a meaningful class describing the character state 136. A conditional mapping can be made by the trained character voice model 244 on the spoken tokens the player audio 128, the voice of the selected character i, and the identified parameters P from □. □(□,□,□)=□□(□,□)

A more complex model can be built at a higher computational cost by finetuning with additional input parameters from the character state 136. Basically, the model 244 can take as input [Input audio: audio, Target character voice: string, Character's state: string]. The training procedure for the model 244 can consider the additional parameters with a semi-exhaustive list (a classification problem for the character state model 332 to provide the character state 136 and simplify the problem and limit it to a given set of parameters).

In some instances, the players 110, 112 can communicate with each other outside of the game play. This is sometimes called “direct communication”. With direct communication, the trained character voice model 244 can be provided with a default character state 136. The trained voice character model 244 can thus be used outside of the game context and allow a user to disguise their voice.

Suing the trained voice model 140, the player 110, 112 can decide to play with a certain character and use a voice other than their own. The voice can be selected from a displayed database of voices or from a recorded voice of choice. The generated voice can include aspects of the voice of the player 110, 112 or not.

If the player 110, 112 is a female or a child, for example, the voice generated by the trained voice model 140 can have typical male voice characteristics. Such configurations help preserve player 110, 112 privacy, reduce chances that the player 110, 112 is bullied, and increase the changes of the player 110, 112 being accepted as part of the game community.

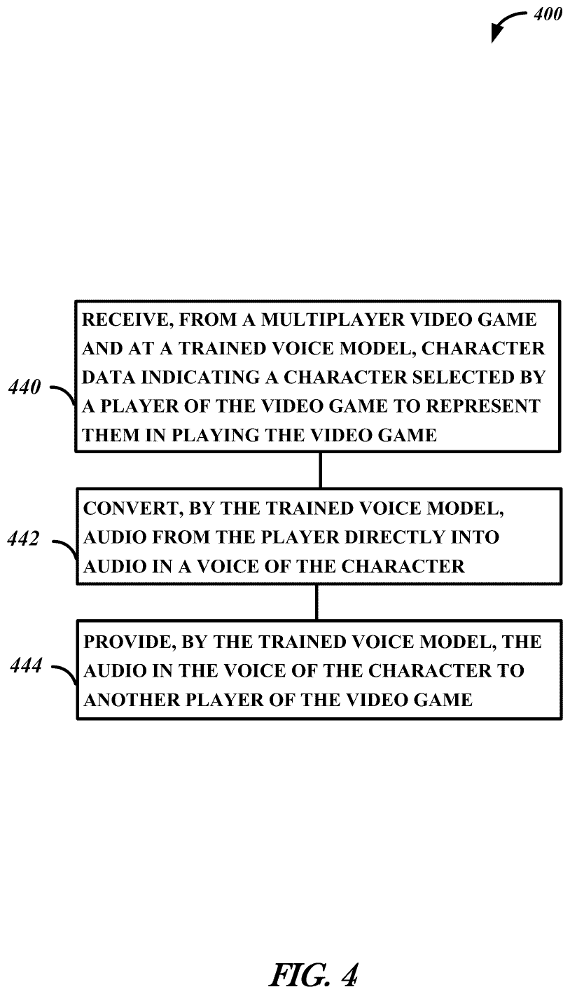

FIG. 4 illustrates, by way of example, a diagram of an embodiment of a method 400 for voice synthetization in a video game. The method 400 as illustrated includes receiving, from a multiplayer video game and at a trained voice model, character data indicating a character selected by a player of the video game to represent them in playing the video game, at operation 440; converting, by the trained voice model, audio from the player directly into audio in a voice of the character, at operation 442; and providing, by the trained voice model, the audio in the voice of the character to another player of the video game, at operation 444.

The trained voice model can include a sequence-to-sequence model that is trained, in a supervised manner, to convert a spectrogram of the audio from the player to a spectrogram consistent with the voice of the character. The operation 442 can be performed based on a game log that includes data indicating a state of characters, including the character, actively operating in the video game.

The method 400 can further include receiving, from a character state model and at the trained voice model, the character state, the character state model trained to generate, based on the game log, the character state of the character. The character state can be constrained to include only parameters of the character state that affect the voice of the character and that the trained voice model uses to alter the voice of the character. The character state of the players can include an environment about the characters in the video game, a physical state of the characters in the video game, and a movement state of the characters in the video game.

The trained voice model can include a trained character voice model trained to generate, for a plurality of characters including the character and for a plurality of character states, a character spectrogram consistent with a selected character and a given character state. The trained voice model can include a vocoder configured to synthesize the audio in the voice of the character based on the character spectrogram.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The trained voice model 140, speaker encoder 336, trained character voice model 244, character state model 332, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

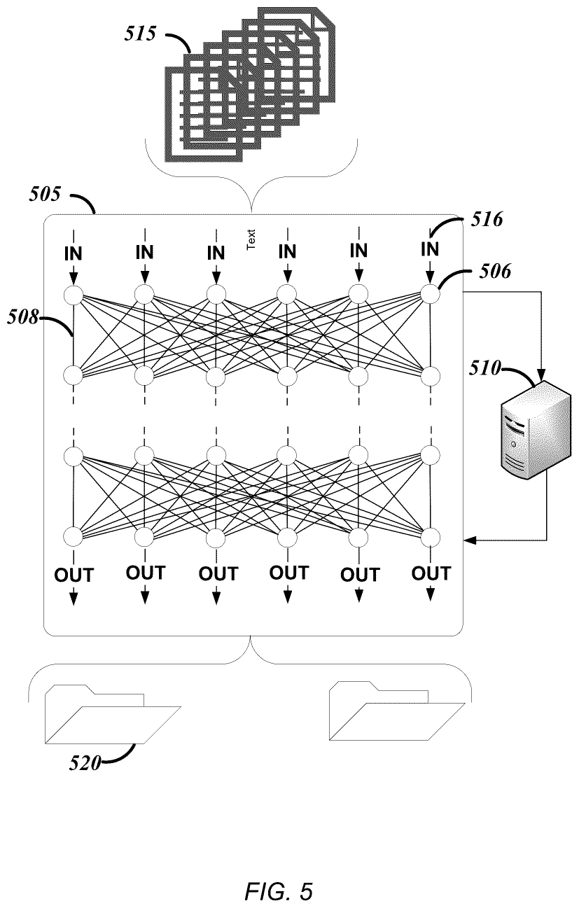

FIG. 5 is a block diagram of an example of an environment including a system for neural network (NN) training. The system includes an artificial NN (ANN) 505 that is trained using a processing node 510. The processing node 510 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 505, or even different nodes 506 within layers. Thus, a set of processing nodes is arranged to perform the training of the ANN 505. The trained voice model 140, speaker encoder 336, trained character voice model 244, character state model 332, a combination thereof, or the like can be trained using the system.

The set of processing nodes is arranged to receive a training set 515 for the ANN 505. The ANN 505 comprises a set of nodes 506 arranged in layers (illustrated as rows of nodes 506) and a set of inter-node weights 508 (e.g., parameters) between nodes in the set of nodes. In an example, the training set 515 is a subset of a complete training set. Here, the subset may enable processing nodes with limited storage resources to participate in training the ANN 505.

The training data may include multiple numerical values representative of a domain, such as an image feature, or the like. Each value of the training or input 516 to be classified after ANN 505 is trained, is provided to a corresponding node 506 in the first layer or input layer of ANN 505. The values propagate through the layers and are changed by the objective function.

As noted, the set of processing nodes is arranged to train the neural network to create a trained neural network. After the ANN is trained, data input into the ANN will produce valid classifications 520 (e.g., the input data 516 will be assigned into categories), for example. The training performed by the set of processing nodes 506 is iterative. In an example, each iteration of the training the ANN 505 is performed independently between layers of the ANN 505. Thus, two distinct layers may be processed in parallel by different members of the set of processing nodes. In an example, different layers of the ANN 505 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 506 (e.g., neurons) are trained independently. In an example, the nodes are trained on different hardware.

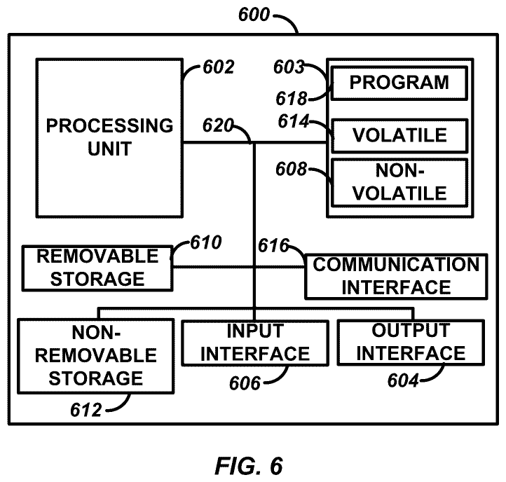

FIG. 6 is a block schematic diagram of a computer system 600 to perform voice synthetization in accord with systems, devices, methods, and algorithms according to example embodiments. Any of the components or operations of the multiplayer game 144, select character interface 130, identify character state operation 134, trained voice model 140, compute device 118, 120, controller 124, 126, headset 146, 148, operations 230, 232, the trained character voice model 244, the speaker encoder 336, the vocoder 342, the character state model 332, method 400, or other component or operation can be implemented using the system 600 or a component thereof. All components of the system 600 need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 6. Devices, such as smartphones, tablets, and smartwatches, are generally collectively referred to as mobile devices or user equipment.

Although the various data storage elements are illustrated as part of the computer 600, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 618 along with the workspace manager 622 may be used to cause processing unit 602 to perform one or more methods or algorithms described herein.

### Examples and Additional Notes

Example 1 includes a system comprising a multiplayer video game including a character selection interface through which a player selects a character to represent them in playing the video game, and a voice model trained to convert audio from the player directly into audio in a voice of the character and provide an output that includes the audio in the voice of the character.

In Example 2, Example 1 further includes, wherein the trained voice model includes a sequence-to-sequence model that converts a spectrogram of the audio from the player to a spectrogram consistent with the voice of the character.

In Example 3, at least one of Examples 1-2 further includes, wherein the video game is configured to generate a game log including data indicating character states of characters, including a character state of the character, of the video game.

In Example 4, Example 3 further includes a character state model, the character state model trained to (i) generate, based on the game log, a character state of the character and (ii) provide the character state as input to the trained voice model.

In Example 5, Example 4 further includes, wherein the character state is constrained to include only parameters of the character state that affect the voice of the character and that the trained voice model uses to alter the voice of the character.

In Example 6, at least one of Examples 3-5 further includes, wherein the state of the players represents an environment about the characters in the video game, a physical state of the characters in the video game, and a movement state of the characters in the video game.

In Example 7, at least one of Examples 1-6 further includes, wherein the trained voice model includes a trained character voice model trained to generate, for a plurality of characters including the character and for a plurality of character states, a character spectrogram consistent with a selected character and a given character state, and a vocoder configured to synthesize the audio in the voice of the character based on the character spectrogram.

In Example 8, Example 7 further includes a speaker encoder model trained to generate a speaker encoding of the audio of the player and provide the speaker encoding as input to the trained character voice model, wherein the trained character voice model maintains characteristics of the voice of the player in the player audio in the voice of the character.

In Example 9, Example 8 further includes, wherein the characteristics include volume, rhythm, and rate.

In Example 10, at least one of Examples 3-9 further includes, wherein the video game is configured to update the game log for each frame of the video game and the character state is updated for each frame.

Example 11 includes a method comprising receiving, from a multiplayer video game and at a trained voice model, character data indicating a character selected by a player of the video game to represent them in playing the video game, converting, by the trained voice model, audio from the player directly into audio in a voice of the character, and providing, by the trained voice model, the audio in the voice of the character to another player of the video game.

In Example 12, Example 11 further includes, wherein the trained voice model includes a sequence-to-sequence model that is trained, in a supervised manner, to convert a spectrogram of the audio from the player to a spectrogram consistent with the voice of the character.

In Example 13, at least one of Examples 11-12 further includes, wherein converting the audio from the player is performed based on a game log that includes data indicating a state of characters, including the character, actively operating in the video game.

In Example 14, Example 13 further includes receiving, from a character state model and at the trained voice model, the character state, the character state model trained to generate, based on the game log, the character state of the character.

In Example 15, Example 14 further includes, wherein the character state is constrained to include only parameters of the character state that affect the voice of the character and that the trained voice model uses to alter the voice of the character.

In Example 16, at least one of Examples 13-15 further includes, wherein the character state of the players includes an environment about the characters in the video game, a physical state of the characters in the video game, and a movement state of the characters in the video game.

In Example 17, at least one of Examples 11-16 further includes, wherein the trained voice model includes a trained character voice model trained to generate, for a plurality of characters including the character and for a plurality of character states, a character spectrogram consistent with a selected character and a given character state, and a vocoder configured to synthesize the audio in the voice of the character based on the character spectrogram.

Example 18 includes a non-transitory machine-readable medium including instructions that, when executed by a machine, cause the machine to perform operations for voice synthetization in a multiplayer video game, the operations comprising receiving, from the multiplayer video game and at a trained voice model, character data indicating a character selected by a player of the video game to represent them in playing the video game, converting, by the trained voice model, audio from the player directly into audio in a voice of the character, the trained voice model including a sequence-to-sequence transformer model trained, in a supervised manner, to convert a spectrogram of audio from the player to a spectrogram consistent with the voice of the character, and providing, by a vocoder of the trained voice model, the audio in the voice of the character to another player of the video game.

In Example 19, Example 18 further includes, wherein the operations further comprise generating, by a speaker encoder model, a speaker encoding of the audio of the player and providing the speaker encoding as input to the trained character voice model, wherein the trained character voice model maintains characteristics of the voice of the player in the player audio in the voice of the character.

In Example 20, Example 19 further includes, wherein the characteristics include volume, rhythm, and rate.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine. Thus, a module can include software, hardware that executes the software or is configured to implement a function without software, firmware, or a combination thereof.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A system comprising:
a multiplayer video game including a character selection interface through which a player selects a character to represent them in playing the video game; and
a voice model trained to convert audio from the player directly into audio in a voice of the character and provide an output that includes the audio in the voice of the character.

2. The video game system of claim 1, wherein the trained voice model includes a sequence-to-sequence model that converts a spectrogram of the audio from the player to a spectrogram consistent with the voice of the character.

3. The video game system of claim 1, wherein the video game is configured to generate a game log including data indicating character states of characters, including a character state of the character, of the video game.

4. The video game system of claim 3, further comprising a character state model, the character state model trained to (i) generate, based on the game log, a character state of the character and (ii) provide the character state as input to the trained voice model.

5. The video game system of claim 4, wherein the character state is constrained to include only parameters of the character state that affect the voice of the character and that the trained voice model uses to alter the voice of the character.

6. The video game system of claim 3, wherein the state of the players represents an environment about the characters in the video game, a physical state of the characters in the video game, and a movement state of the characters in the video game.

7. The video game system of claim 1, wherein the trained voice model includes:
a trained character voice model trained to generate, for a plurality of characters including the character and for a plurality of character states, a character spectrogram consistent with a selected character and a given character state; and
a vocoder configured to synthesize the audio in the voice of the character based on the character spectrogram.

8. The video game system of claim 7, further comprising a speaker encoder model trained to generate a speaker encoding of the audio of the player and provide the speaker encoding as input to the trained character voice model, wherein the trained character voice model maintains characteristics of the voice of the player in the player audio in the voice of the character.

9. The video game system of claim 8, wherein the characteristics include volume, rhythm, and rate.

10. The video game system of claim 3, wherein the video game is configured to update the game log for each frame of the video game and the character state is updated for each frame.

11. A method comprising:
receiving, from a multiplayer video game and at a trained voice model, character data indicating a character selected by a player of the video game to represent them in playing the video game;
converting, by the trained voice model, audio from the player directly into audio in a voice of the character; and
providing, by the trained voice model, the audio in the voice of the character to another player of the video game.

12. The method of claim 11, wherein the trained voice model includes a sequence-to-sequence model that is trained, in a supervised manner, to convert a spectrogram of the audio from the player to a spectrogram consistent with the voice of the character.

13. The method of claim 11, wherein converting the audio from the player is performed based on a game log that includes data indicating a state of characters, including the character, actively operating in the video game.

14. The method of claim 13, further comprising receiving, from a character state model and at the trained voice model, the character state, the character state model trained to generate, based on the game log, the character state of the character.

15. The method of claim 14, wherein the character state is constrained to include only parameters of the character state that affect the voice of the character and that the trained voice model uses to alter the voice of the character.

16. The method of claim 13, wherein the character state of the players includes an environment about the characters in the video game, a physical state of the characters in the video game, and a movement state of the characters in the video game.

17. The method of claim 11, wherein the trained voice model includes:
a trained character voice model trained to generate, for a plurality of characters including the character and for a plurality of character states, a character spectrogram consistent with a selected character and a given character state; and
a vocoder configured to synthesize the audio in the voice of the character based on the character spectrogram.

18. A non-transitory machine-readable medium including instructions that, when executed by a machine, cause the machine to perform operations for voice synthetization in a multiplayer video game, the operations comprising:
receiving, from the multiplayer video game and at a trained voice model, character data indicating a character selected by a player of the video game to represent them in playing the video game;
converting, by the trained voice model, audio from the player directly into audio in a voice of the character, the trained voice model including a sequence-to-sequence transformer model trained, in a supervised manner, to convert a spectrogram of audio from the player to a spectrogram consistent with the voice of the character; and
providing, by a vocoder of the trained voice model, the audio in the voice of the character to another player of the video game.

19. The non-transitory machine-readable medium of claim 18, wherein the operations further comprise generating, by a speaker encoder model, a speaker encoding of the audio of the player and providing the speaker encoding as input to the trained character voice model, wherein the trained character voice model maintains characteristics of the voice of the player in the player audio in the voice of the character.

20. The non-transitory machine-readable medium of claim 19, wherein the characteristics include volume, rhythm, and rate.
